(19) United States
(12) Patent Application Publication
(10) Pub. No.: US 2016/0112678 A1
(43) Pub. Date: Apr. 21, 2016

(54) ROCK DRILLING RIG AND METHOD FOR MONITORING

(71) Applicant: SANDVIK MINING AND CONSTRUCTION OY, Tempere (FI)

(72) Inventor: Henri SUVANEN, Tampere (FI)

(21) Appl. No.: 14/892,528

(22) PCT Filed: May 21, 2013
(86) PCT No.: PCT/EP2013/060377

§ 371 Date: Nov. 19, 2015

(51) Int. Cl. H04N 7/18; E21B 7/00; H04N 5/232; E21B 44/00

(52) U.S. Cl. CPC H04N 7/181; E21B 44/00; E21B 7/00; H04N 5/23293

(57) ABSTRACT

A rock drilling rig and a method of monitoring drilling is provided. The rock drilling rig is provided with a boom and drilling unit therein. Drilling is monitored by a monitoring system having at least one monitoring video camera. Monitoring views of the camera is displayed on a display device. Several operational targets and target views for them are predefined for the system, whereby the target views are shown on the display device during progress of the drilling. The operator may monitor the drilling by the display device.

### BACKGROUND OF THE INVENTION

The invention relates to a rock drilling rig, and particularly to a system for allowing video monitoring during the operation of the rock drilling rig. The invention further relates to a method of monitoring operation of a rock drilling rig, and to a computer program for executing or assisting the monitoring.

The field of the invention is defined more specifically in the preambles of the independent claims.

In mines and other work sites, various rock drilling rigs are used for drilling boreholes into rock surfaces. The rock drilling rig is provided with a boom and a drilling unit in the boom. The boom is moved during the use between different working positions and the drilling unit comprises several devices, which are to be controlled by an operator. Thus, controlling the drilling is a demanding task and requires use of several control devices. The rock drilling rig may be provided with a video camera allowing monitoring operation of the rock drilling rig. However, the known video monitoring systems have drawbacks especially when considering their user-friendliness.

### BRIEF DESCRIPTION OF THE INVENTION

An object of the invention is to provide a novel and improved rock drilling rig and a method for video monitoring operation of the rock drilling rig.

The rock drilling rig according to the invention is characterized in that several operational targets are predefined for the control unit; at least one target view for the first camera is determined for each of the operational targets; and the control unit is configured to display the determined target views on the display device according to at least one predetermined control principle.

The method according to the invention is characterized by displaying on a display device monitoring camera views of predefined operational phases and objects relating to drilling.

An idea of the disclosed solution is that the rock drilling rig comprises one or more control units provided with several predefined operational targets. Further, one or more target views for the used one or more cameras are determined for each of the predetermined operational targets. The operational targets and the targets views are utilized when video monitoring operation of the rock drilling rig. The control unit may also comprise one or more control principles or strategies according to which data received from the cameras is displayed on one or more display device arranged for the operator. Then, the determined target views of the relevant operational targets are offered for the operator.

An advantage of the disclosed solution is that the operator is provided with focused and visualized information for assisting the controlling of the various operating situations of the drilling unit and the boom. Thus, work of an operator becomes easier and more effective and it becomes possible to avoid or at least reduce manual camera control, which is especially advantageous for remote control operations and certain control operations requiring both hands.

According to an embodiment, one or more operational targets are physical objects of the drilling unit. The monitoring system may be arranged to monitor desired devices and components of the drilling unit, and may be arranged to display them on the display device. The monitored objects may be preset or the operator may decide what the objects to be monitored and displayed are.

According to an embodiment, one operational physical target in a drilling unit is a drilling machine. The drilling machine may be monitored when connecting a new drill rod to a shank, for example.

According to an embodiment, one operational physical target in a drilling unit is a drill bit. Position of the drill bit defines a start point of a new drill hole to be drilled, whereby monitoring of the drill bit is reasonable. Further, condition of the drill bit may be monitored.

According to an embodiment, one operational physical target in a drilling unit is a feed beam. Position and direction of the feed beam may be detected by means of the monitoring view. The direction of the feed beam determines direction of a drill hole to be drilled, wherefore need for the monitoring occurs at least when initiating a new drill hole.

According to an embodiment, one operational physical target in a drilling unit is a retainer device. Retainer device is used when changing drilling components. A proper operation of the retainer may then be monitored.

According to an embodiment, one operational physical target in a drilling unit is gripping jaws. Gripping device is used when changing drilling components. A proper operation of the gripping jaws may then be monitored.

According to an embodiment, one operational physical target in a drilling unit is a drilling component changing device, or component transfer device. By means of the monitoring view the operator may note that the changing device operates properly.

According to an embodiment, one operational physical target in a drilling unit is a drilling component magazine. Typically the component magazine is used in a so called extension rod drilling, wherein two or more drill rods are connected to each other in order to form an extension rod. Then several drill rods are stored in the rod magazine, which may be located at the drilling unit or sometimes on a carriage. In addition to drill rods, the component magazine may be used for storing drill bits, for example. Monitoring the component magazine may be needed to ensure that the magazine works properly. A video monitoring view may indicate presence of a drilling component in a feed opening allowing a component change to be initiated. Further, the monitoring view may show free spaces in the magazine among other things.

According to an embodiment, one operational physical target in a drilling unit is a joint between drilling components. The joint may be provided between a shank of a drilling machine and a tool, and the joints may be between successive extension rods of the tool. Further, a drill bit may be connected to an outermost end of the tool by means of the joint. Typically the joints are screw joints and their current state may be monitored by means of video monitoring.

According to an embodiment, one or more operational targets are positions of the boom. The boom can be moved in a versatile manner and it may comprise two or more booms parts and connecting joints between them. Thus, the boom and a drilling unit arranged therein can be positioned to locations which are worth to monitor. The monitored boom positions may be predetermined static positions of the boom, or they may be dynamic position states allowing monitoring of the boom when being moved towards the desired boom position.

According to an embodiment, one operational target to be monitored is positioning a boom to a drilling position. The control unit may control a monitoring camera to focus to a start point of a drill hole to be drilled and may display the start point for the operator, whereby positioning of a drill bit is facilitated. The operator sees on a display device if the planned start point is not suitable for the drilling and that better rock surface may locate nearby. Further, the operator may determine on the basis of the video data that there is sufficiently free space to position the drilling unit and to drill the drill hole properly.

According to an embodiment, one operational target to be monitored is driving a boom between a transport position and a drilling position. The boom may be positioned to the predetermined transport position for the duration of driving and transporting of the rock drilling rig. When in the transport position, the boom is driven to a closed position, where it is in a short configuration and in a low position. Then the boom and a drilling unit therein take as little space as possible and the center of mass is located at low height. A carrier of the rock drilling rig may comprise a physical transport support on which the boom is driven when in the transport position. Due to a complicated structure of the boom and the drilling unit, there often occurs a need to drive the boom according to a predetermined boom moving sequence from the closed transport position to the open drilling position. The boom may be controlled so as to move the drilling unit and boom parts via one or more pre-determined intermediate positions when moved between the transport position and the drilling position. This way, the boom may be moved through a collision free path. The movement path is not always the shortest one, but collision against a control cabin, a carrier, other booms or parts of the rock drilling rig, rock surfaces, and the ground can be avoided. This embodiment allows video monitoring of the driving steps of the boom. The monitoring system may be arranged to provide video data of the boom when being moved. Moreover, hydraulic hoses, electric cables and sensors may require that the boom needs to be moved according to pre-determined steps in order to avoid them to be damaged. Further, if there is a special situation or a physical part of the boom or the drilling unit to be monitored, then the control unit may be arranged to display it automatically. Further, the control unit may be arranged to control the monitoring camera automatically and to focus on the monitored situation or object. The transport position may be located on a side of a control cabin, whereby a poor visibility to the transport makes the driving of the boom difficult. Then one or more cameras may be directed towards the transport position. The monitoring system may be arranged to provide video data of one or more critical positions or places of the boom and obstacles.

According to an embodiment, a rock drilling rig is provided with two or more booms. Then, the control unit may be arranged to monitor the booms and their relative positions. Thus, in this embodiment one operational target to be monitored is mutual positions between several booms of the drilling rig. The control unit may also comprise a collision control feature, which is arranged to monitor positions of the booms and to inform the operator in case of possible collision between the booms. The control unit may display on a display device booms which operate so close to each other that there occurs a risk for a collision. The control unit may also give an alarm signal.

According to an embodiment, one or more operational targets are work phases relating to a drilling. The drilling comprises several successive drilling phases. In order to carry out the drilling, several assisting operations may also be needed. This embodiment allows that these work phases are monitored and displayed for the operator.

According to an embodiment one work phase to be monitored is a fine positioning step of a drill bit to a start point of a hole to be drilled. Visibility to the start point may be poor. This embodiment allows the operator to position and direct a drilling unit properly so that the planned drill holes can be drilled accurately.

According to an embodiment one work phase to be monitored is a search of a proper starting location for a starting point. This feature is advantageous when the planned rock surface is fractured, sloping or is otherwise difficult for supporting a drilling unit against it and to start collaring. Further, the operator may clearly see spacing between realized drill holes and the planned drill hole.

According to an embodiment one work phase to be monitored is a collaring step. When a drilling of a drill hole is initiated it is usually important to monitor that a drill bit penetrates into a rock as desired and that the set position and direction are maintained. In case deviations are notified, then corrective actions may be launched at a very beginning of the drilling. The collaring step may be displayed for the operator for a predetermined time period or until a preset depth is reached, for example.

According to an embodiment one work phase to be monitored is a search of a start point of a next drill hole to be drilled. The next start point may be searched in advance when a previous drill hole is still under drilling operation. Typically the next drill hole is relatively close to the previous drill hole, whereby the drilling unit under the drilling operation may block visibility preventing search of the next start point. By means of video monitoring it is possible to have a proper view of a surrounding of the previous drill hole. Alternatively, this embodiment allows examination of any location of the rock surface under operation.

According to an embodiment one work phase to be monitored is a work phase relating to handling of drill components. The drill components, such as drill bits, drill rods and extensions rods, may be stored to a component magazine, for example. Operation of the component magazine may be monitored and displayed for the operator. When the component magazine is moved in order to receive or offer the drilling component, the visual monitoring data may be provided for the operator. The drilling component may be moved between the component magazine and drilling axis by means of a transfer device the operation, which may also be video monitored. Further, operations of any other devices, such as a retaining device or gripping devices, relating to adding or removing drill components, may be monitored and their currently active operation displayed to operator.

According to an embodiment, a PTZ camera is used for the disclosed video monitoring. The Pan-Tilt-Zoom camera may be adjusted in a versatile manner so that it may be directed and zoomed to desired operational targets. The camera may comprise one or more servo motors for moving the camera and one or more servo motors for zooming it.

According to an embodiment, the rock drilling rig is provided with a control cabin and one or more video monitoring cameras are arranged inside the control cabin. An advantage of this solution is that the camera is protected against moisture, dirt and physical blows when being in the control cabin or in similar closed space.

According to an embodiment, the rock drilling rig is provided with a control cabin and one or more video monitoring are arranged on a top of the control cabin. Then the camera may be turned around and is located above visual obstructions.

According to an embodiment, one or more video monitoring cameras are arranged on a carrier of a rock drilling rig.

According to an embodiment, one or more video monitoring cameras are arranged to one or more booms of a rock drilling rig. When the camera is arranged to the boom, it automatically follows movements of the boom. Further, when the camera is in the boom, the boom itself seldom forms a visual obstruction.

According to an embodiment, one or more video monitoring cameras are arranged remote from a rock drilling rig. Then the camera may be arranged to a support, which may be positioned in a desired place at a work site. Such remote camera allows wide selection of target views. Between the remote camera and a control unit may be a wireless data transfer connection, so that control commands may send from the control unit to control devices of the camera and camera signals may be send from the camera to the control unit.

According to an embodiment, one or more cameras of a video monitoring system comprise night vision systems allowing video monitoring in darkness.

According to an embodiment, one or more cameras of a video monitoring system are infrared cameras allowing video monitoring in darkness and when visibility to an object is poor. By means of thermographic video data it is possible to follow operation of active devices, which produce heat during their use. Further, it is possible to note condition of machine parts, for example. The infrared cameras may also be utilized in a collision control when detecting humans in the work site, for example.

According to an embodiment, the rock drilling rig comprises one or more cameras arranged to video monitor one or both drive directions of the carrier. The carrier may be provided with four cameras arranged at corners or the carrier. The cameras may be stationary cameras fastened immovably to the carrier. Alternatively, the cameras may comprise moving members allowing their versatile movements to desired directions. A monitoring system may be arranged to display camera views of these monitoring cameras automatically when a carrier of the rock drilling rig is moved or a control device related to driving is actuated. Thus, an overall view in the driving direction is offered for the operator.

According to an embodiment, one or more operational targets to be monitored are provided with predetermined target views. The target views may be stored in a memory media readable by a control unit. Determining the target view may comprise determining which camera is to be used, direction of the camera and zooming of the camera. The target view is displayed to the operator during the monitoring. An advantage of this embodiment is the most illustrating view is shown for the operator quickly and without any extra work during the drilling operation.

According to an embodiment, a monitoring system comprises predetermined target views for one or more monitored operational targets. Further, the target views are taught to the monitoring system by a manual control of directing and zooming of a monitoring camera. The taught target views may be stored as factory settings. In addition to this, the system may allow the operator to create desired target views by the teaching process and to add them into the system. Further, the operator may amend the preset target views by the teaching process.

According to an embodiment, one or more operational targets are moved during a monitoring and a control unit is arranged to automatically control one or more monitoring cameras so that they are “locked” to the moving targets. Thus, the camera may follow the target by changing a direction, and also zooming if distance is changed significantly.

According to an embodiment, the operational target is moved during the monitoring and the rock drilling rig comprises measuring means for determining actual position of the monitored operational target. Based on the measuring data, the control unit is configured to control directing of the monitoring camera to automatically follow the moving operational target.

According to an embodiment, a boom and a drilling unit may be provided with sensors or measuring devices, such as angle sensors in connection with joints, for providing measuring data. The measuring data is transmitted to a control unit, which may determine on the basis of the measuring data and stored data of physical configuration, dimensions and kinematics of the boom and the drilling unit the positions and directions of monitored operational targets. The control unit may comprise a processing device and a suitable program for executing needed calculations for the position determination. The control unit, or another control unit, may determine the current heading of the camera on the basis of coordinate movements or camera heading sensor, for example. Target heading for the camera may be determined based on the current position of the operational target. Required orientation action is defined to align the camera to the target heading, and the camera is accordingly automatically controlled.

According to an embodiment, the monitoring system may comprise a pattern recognition system or a movement detection system for detecting moving of an operational target. The received detection data may be utilized for controlling one or more monitoring cameras and displaying of their camera views.

According to an embodiment, one or more monitored operational targets of a rock drilling rig may be provided with transmitters, which may send signals, such as radio signals. One or more monitoring cameras may comprise receivers for receiving the transmitted signals and identifying the transmitter. The monitoring camera may be directed towards to transmitter on a basis of strength of the received signal. Thus, the monitoring camera may follow the operational target. The signal may comprise identification code ensuring that only the predetermined monitoring camera will be controlled by the received signal.

According to an embodiment, one or more monitoring cameras are arranged to follow moving operational target in steps. Then, the monitoring camera may be directed so that the directing procedure comprises alternating still periods and moving periods. Durations of the periods may be adjusted as desired by the operator. Also zooming of the monitoring camera may be stepwise. Alternatively, the directing and zooming of the monitoring camera may follow the moving target continuously, but instead camera views may be displayed in steps comprising still periods and moving periods. An advantage of these embodiments is that more operator friendly camera views are offered and a kind of seasickness of the operator can be avoided. If the camera view is moving all the time, it may cause harmful mental loading for the operator. The disclosed still periods may remove this problem.

According to an embodiment, one or more monitoring cameras are arranged to follow a moving operational target, whereby directing and zooming of the cameras may be automatically controlled according to the movements of the operational target. Speed of the directing and zooming of the monitoring camera during the automatic following procedure may be adjustable. The monitoring speed may be adjusted according to a personal desire of the operator. Thanks to personal adjustments operator's mental loading may be decreased.

According to an embodiment, the rock drilling rig comprises several monitoring cameras having fixed directions, whereby each of the monitoring cameras has one single operational target. The fixed cameras may be relatively simple and inexpensive, and further, control of camera views may also be simple. Thus, a dedicated monitoring camera may be arranged to monitor every interesting object relating to rock drilling. It is also possible to arrange two or more fixed monitoring cameras to monitor a common object, whereby visibility is always guaranteed. The operator may prioritize one camera view over the others according to personal desires. In addition to the fixed direction, zooming of the cameras may also be fixed. Then each monitoring camera has one single target view, which cannot be changed. Such fixed cameras may be arranged in connection with a retainer, gripping jaws and a component magazine, for example. The fixed camera may be small in size and have durable structure, whereby it may be arranged in connection with a monitored device or system, or close to it.

According to an embodiment, at least one control unit arranged to produce control data for one or more monitoring cameras is located remote to a rock drilling rig and a remote control space. Then, the control unit may be a server device, which co-operates with an on-board control unit and with a possible remote control unit in the remote control space. Data transmission is arranged between the control units.

According to an embodiment, a control unit is configured to automatically change target views of operational targets as a response to change in an operational state of the rock drilling rig. For example, when a drilling process is monitored, a change in the drilling process is notified by the control unit and the target view may be changed accordingly. The control unit may control one or more cameras and one or more display units for automatically showing video data related to the current work phase.

According to an embodiment, a control unit is configured to automatically display on a display device target views of operational targets according to received control commands from first control means of a drilling boom or second control means of a drilling unit. Thus, when the boom or the drilling unit is in use and under active control, then monitoring is activated. Thanks to this embodiment, actively controlled operational targets are automatically displayed on the display device. The control unit may prioritize displaying of the actively controlled object. The automatic display feature allows the operator to concentrate on controlling the actual drilling.

According to an embodiment, a user interface of a control unit comprises one or more fast selects allowing the operator to select desired operational targets and prioritize displaying of the selected operational targets on a display device. The fast select may define a physical part of a rock drilling rig, such as a component magazine, a feed beam, a retainer or a boom to be displayed. Alternatively, the fast select may define a drilling phase, a drilling component change or any other work phase or situation to be displayed on the display device.

According to an embodiment, a control unit is provided with at least one drilling sequence allowing automatic control and change of drilling work phases of at least one drill hole. Further, target views are determined for predetermined drilling work phases of the drilling sequence, whereby execution of the drilling sequence in the control unit is configured to automatically change the target views on the display device according to progress of the drilling process. In response to the at least partly autonomous drilling sequence automatically changing from a first drilling work phase to a second drilling work phase, a target view associated with the second work phase is displayed. The drilling sequence may also control changes of drilling components, whereby the control unit displays automatically work phases related to removing and adding of drilling components to drill axis and possibly also work phases relating to storing and handling of the drilling components, such as drill rods and drill bits. In addition to the display device, the control unit may also control one or more monitoring cameras according to the progress of the drilling process and changes in operational stages of a drilling unit and the whole rock drilling rig.

According to an embodiment, a control system comprises a user interface provided with one or more control members allowing manual directing and zooming of one or more video monitoring cameras to desired targets. The control system may further comprise a feature allowing interruption of the manual control of the camera at any moment, whereby the control system takes the camera into an automatic control. On the other hand, the automatic control of the camera may be interrupted whenever the manual control is initiated. As an example, the camera may follow collaring of a drill hole in an automatic mode and when the operator desires to monitor operation of a component magazine a manual control command may be given. When the desired monitoring is completed and the manual control is finished then the monitoring system may return to the automatic control mode.

According to an embodiment, the rock drilling rig is an unmanned device, which is remote controlled by means of teleoperation. Then a control unit, a user interface, a display device and control means may locate remote to the rock drilling rig. The mentioned control devices may be located in a remote space, such as a control room outside or inside a mining area, or in a van or another vehicle. Thus, the operation of the rock drilling rig is controlled by a remote operator on the basis of the video monitoring data displayed on the display device. The unmanned rock drilling rig may or may not comprise a control cabin and additional control devices therein.

According to an embodiment, the rock drilling rig is a manned device, which is controlled by an on-board operator. Then a control unit is configured to display on a display unit visual data of operational targets for assisting the on-board operator. The monitoring system may show to the operator monitoring views of the currently active devices and operations relating to the rock drilling. Further, the monitoring system may assist the operator by showing objects and situations, which are in blind angles relative to visual field of the operator.

According to an embodiment, the rock drilling rig is a surface rock drilling rig, which is designed for above ground drilling. The surface rock drilling rigs are used in opencast mines, in road and railway work sites and in construction sites. Typically the surface rigs are provided with only one drilling boom and a drilling unit therein.

According to an embodiment, the rock drilling rig is an underground rock drilling rig. These types of rock drilling rigs are used in underground production mines when excavating ore, and also in tunnel work sites and other contracting work sites when creating different rock cavities and storage halls. The rock drilling rig may comprise only one drilling boom, or alternatively two, three or even more drilling booms.

According to an embodiment, the rock drilling rig is a bolting device comprising one or more drilling machines and one or more bolting units. At first a drill hole is drilled and after that a reinforcing element, such as a rock bolt, is inserted into the drilled hole. The drilling machine and the bolting unit may be arranged so that they can be indexed. The monitoring system disclosed in this application may be arranged to monitor not only the drilling boom, drilling unit and the drilling phase but also the bolting unit and work phases related to the bolting.

According to an embodiment, the disclosed monitoring procedures, camera control procedures and displaying procedures may be carried out by executing one or more software or computer program designed for the purpose. The computer program comprises program code means configured to execute the disclosed actions and steps when being run on a computer or processing device.

The above disclosed embodiments can be combined in order to form suitable solutions provided with necessary features.

### BRIEF DESCRIPTION OF THE FIGURES

Some embodiments are described in more detail in the accompanying drawings, in which

FIG. 1 is a schematic side view showing a rock drilling rig suitable for surface working sites,

FIG. 2 is a schematic side view showing a rock drilling rig for underground working sites,

FIG. 3 is a schematic side view showing a rock drilling unit provided with a component magazine and component handling means,

FIG. 4 illustrates a control block diagram of a monitoring system allowing monitoring drilling and drilling related devices,

FIG. 5 is a schematic top view illustrating a rock drilling rig and an arrangement for using a monitoring camera to search a suitable starting point for a drill hole to be drilled next, and

FIG. 6a is a schematic side view illustrating a rock drilling rig in a drilling position and FIG. 6b illustrates the same in a transport position.

For the sake of clarity, the figures show some embodiments of the disclosed solution in a simplified manner. In the figures, like reference numerals identify like elements.

### DETAILED DESCRIPTION OF SOME EMBODIMENTS

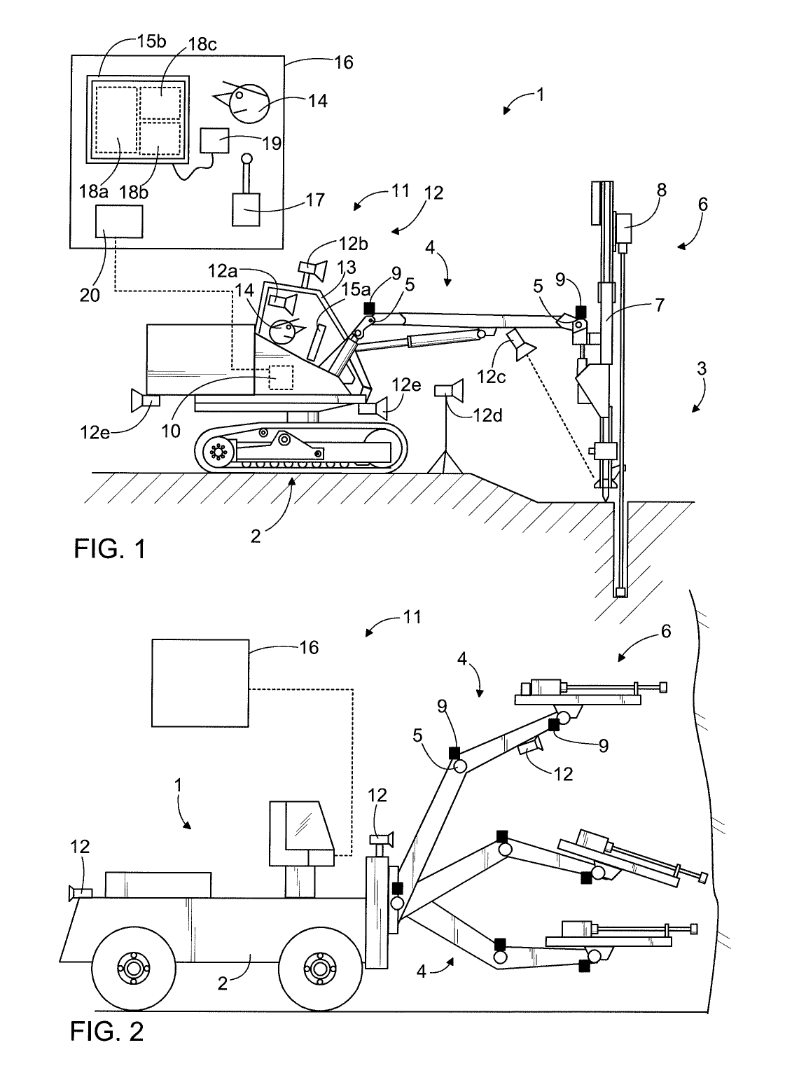

FIG. 1 shows a rock drilling rig 1, in this case a surface drilling device designed for drilling above the ground. The rock drilling rig 1 comprises a movable carrier 2 that can be transport driven to a work site 3. The rock drilling 1 is provided with a boom 4, which may comprise several boom parts and joints 5 between them. A distal end of the boom 4 is provided with a rock drilling unit 6 comprising a feed beam 7 and a rock drilling machine 8 supported to the feed beam 7.

The boom 4 may be provided with one or more sensors 9, measuring devices or other positioning detection means for determining the position of the boom 4 and the drilling unit 6. Sensors 9 may be arranged in connection with boom joints 5, for example. Measuring data of the sensing means is transmitted to a control unit 10 of the mining vehicle 1. The control unit 10 may determine the position of the boom 4 and the detected position data may be taken into account in a control of a monitoring system 11.

The monitoring system 11 comprises one or more monitoring cameras 12 allowing video monitoring of predetermined operational targets, which may relate to drilling process and devices relating to drilling. Camera signals may be transmitted to the control unit 10.

The rock drilling 1 may also include a control cabin 13 on the carrier 2. The control cabin 13 may be provided with suitable control members for controlling the drilling operation and the whole mining vehicle 1. One or more monitoring cameras 12a may be located inside the control cabin 13. It is also possible to arrange a camera 12b on top of the control cabin. The boom 4 may be provided with a monitoring camera 12c, too. In addition to, one or more remote cameras 12d may also be utilized. The monitoring cameras 12a-12d may be used to monitor objects or situations relating to the drilling or assisting the drilling. The monitoring cameras 12 may be directed and zoomed towards different operating targets. Further, the carrier 2 may be provided with one or more cameras 12e for monitoring driving directions of the rock drilling rig 1. The cameras 12e may also give an overall view of the work site 3.

The rock drilling rig 1 is controlled by an operator 14. The rock drilling rig 1 may be manned, whereby the operator 14 is in the control cabin 13. Then the monitoring system 11 comprises one or more display devices 15. At least one display device 15a is in the control cabin 13 for displaying video monitoring data to the operator 14. Alternatively, the device is unmanned and the operator 14 is in a remote control place 16 and a remote control is utilized. The remote control place 16 may locate outside the work site 3 and it may comprise control means 17 for controlling the rock drilling rig 1 by means of monitoring data displayed on a display device 15b. The operator 14 may make selections and feed data to the monitoring system 11 by means of a user interface 19. The remote control place 16 may comprise a control unit 20, which may communicate with the on-board control unit 10 via a wireless data transmission connection. On the other hand, the rock drilling rig 1 may be without the control unit 10, whereby the control unit 20 is the only control unit. On the display devices 15 it is possible to show one or more camera views 18a-18c representing views of the operational targets. For example, camera 12c is directed and zoomed so that collaring of a drill hole may be monitored and the monitoring view may be shown on the display device 15b as a detailed camera view 18c.

FIG. 2 discloses another rock drilling rig 1, which is intended to underground drilling. The rock drilling rig may be provided with several booms 4, position of which may be determined by sensors 9. Operation of the rock drilling rig 1 is monitored by a monitoring system 11 comprising monitoring cameras 12. The monitoring data may be displayed to an operator who may control the device remotely from a remote control place 16 or on-board.

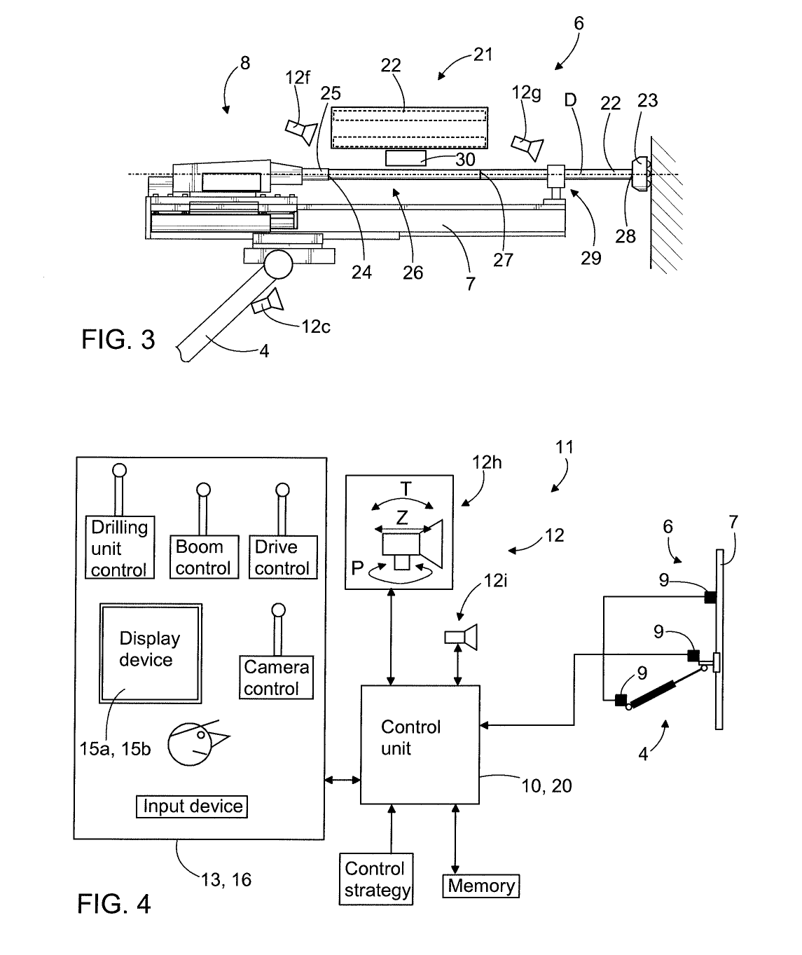

FIG. 3 discloses a drilling unit 6, which is provided with a drilling component magazine 21 wherein several drilling components, such as drill rods 22 or drill bits 23, may be stored. A monitoring camera 12f may be arranged to monitor operation of the component magazine 21. One or more cameras may also be arranged to monitor a joint 24 between a shank 25 and a tool 26, a joint 27 between successive drill rods 22 and a joint 28 between the tool 26 and the drill bit 23. The tool joint comprise connecting means, such as connecting screws. Further, condition of the drill bit 23 may also be monitored. A distal end portion of a feed beam 7 may comprise a retaining device 29, which may utilized for preventing rotation of tool components. The retaining device 29 is mounted on the feed beam 7 so that it is located on the drilling axis D. The retaining device 29 may comprise retaining jaws or corresponding means for gripping the drilling components. The retaining device 29 and work phases relating to connecting and disconnecting the drilling components may be monitored by one or more monitoring cameras 12g. Direction and position of the feed beam 7 may be monitored by means of a camera 12c, which may be arranged to a boom 4, for example. One more monitoring object may be a changing device or transfer device 30 by means of which drilling components may be handled between the drilling axis D and storage means. The monitoring cameras 12 may have a fixed setting, or their direction may be changed.

FIG. 4 shows a monitoring system 11 comprising one or more control units and means for feeding sensing data, control data and commands to the control unit. The operator 14 may use control devices, such as joysticks, for controlling a boom, a drilling unit, a carrier and monitoring cameras.

The operator 14 may also communicate with the control unit by means of a user interface, which may be a touch screen control of a display device. Further, the control unit may read data from one or more memory unit and also store data therein. The control unit may be provided with one or more control strategy or control principle including operating principles and guidelines for controlling cameras and displaying monitoring views on the display device. The control strategy may include an algorithm for automatically directing and zooming the monitoring cameras, and to automatically display operational targets according to predetermined principles. Several examples of different control principles are already disclosed above in this patent application. Data concerning the pre-determined operational targets and targets views may be stored in the memory unit or media. Measuring data is transmitted from different sensors 9, such as boom angle sensors and linear sensors to the control unit. Also any other measuring data is transmitted to the control unit. The control unit may be a computer equipped with an appropriate processor being capable to run a software program including a control algorithm and also processing measuring and control data for producing control information. On the basis of measuring data, manual control commands and the control strategy, the control unit may produce control commands for camera actuators and the display device. Different control principles and situations are disclosed already above in this application.

One or more control units may be located on the rock drilling rig, in a remote control room or elsewhere. Thanks to modern data transmission connections, the position of the control unit may be selected relatively freely.

FIG. 4 further discloses a PTZ-camera 12h, which may be controlled in a versatile manner. The camera 12h may be turned, tilted and zoomed. In addition to PTZ-cameras, several fixed monitoring cameras 12i may be arranged to monitor desired single objects or details of the drilling process, or physical objects of the rock drilling rig.

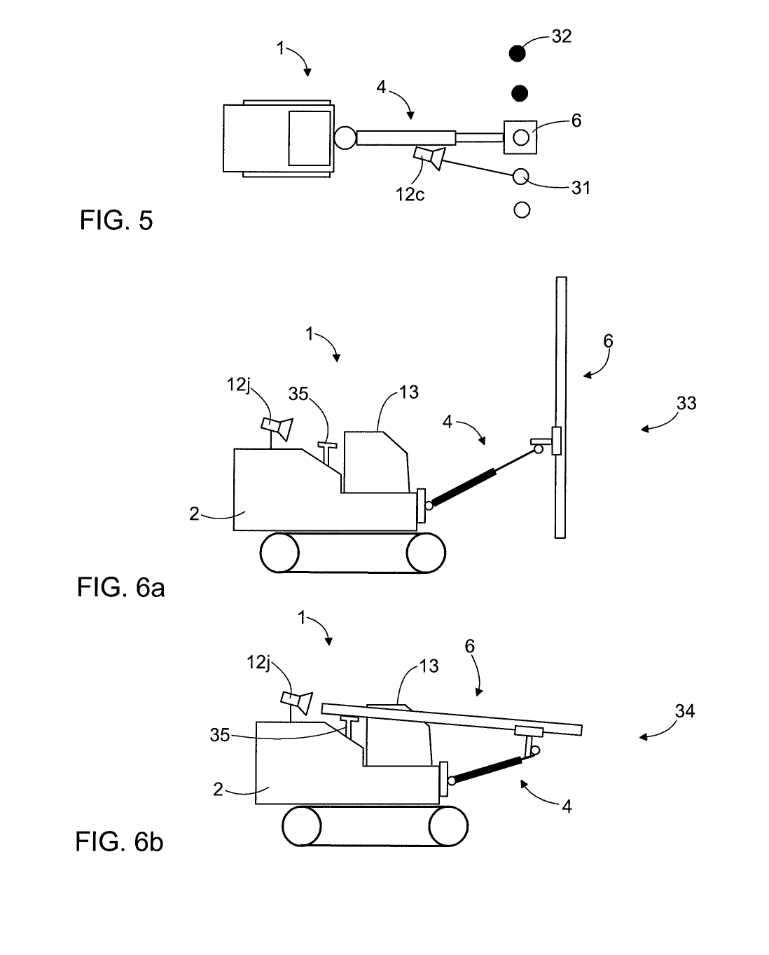

FIG. 5 discloses a rock drilling rig 1, which is provided with a monitoring camera 12c allowing searching a start point 31 of a drill hole to be drilled next. On the basis of the monitoring data, the operator may check beforehand that the drilling of the next hole may be executed without problems. In FIG. 5 already drilled holes are shown as black dots 32 and undrilled drill holes are shown as circles.

FIGS. 6a and 6b illustrate driving of a boom 4 and a drilling unit 6 from a drilling position 33 to a transport position 34. Driving of the boom 4 between the drilling position 33 and the transport position 34 is often a demanding task since there is only a little free space on a carrier 2. Typically the boom 4 has to be moved to the transport position 34 with accurate movement control. Otherwise there is a risk that the boom 4 or the drilling unit 6 may collide a control cabin 13, the carrier 2 or the ground. However, visibility to sides of the control cabin may be poor. To avoid such problems in boom driving a monitoring camera 12j may be utilized. The carrier 2 may comprise a transport support 35, against which the boom 4 can be moved before a transport drive of the carrier 2 is started. The transport support 35 may be arranged next to the control cabin 13. By means of the camera 12j the operator may ensure that the boom 2 is properly supported before starting drive of the carrier 2.

The drawings and the related description are only intended to illustrate the idea of the invention. In its details, the invention may vary within the scope of the claims.

1. A rock drilling rig comprising:
a movable carrier;
at least one drilling boom;
a drilling unit arranged on the drilling boom (4), the drilling unit including a feed beam and a rock drilling machine supported by the feed beam;
at least one first camera allowing video monitoring of drilling;
a first control device arranged to control the drilling boom;
a second control device arranged to control the drilling unit;
at least one control unit arranged to control the drilling according to control data received from the first and second control device, wherein the control unit includes at least one display device arranged to display video monitoring data as a response to the data received from the first camera; and
several operational targets and target views predefined for the control unit; at least one target view for the first camera being determined for each of the operational targets, the control unit being configured to display the determined target views on the display device according to at least one predetermined control principle.

2. The rock drilling rig as claimed in claim 1, wherein at least one operational target is a physical object of the drilling unit (8).

3. The rock drilling rig as claimed in claim 1, wherein at least one operational target is a position of the boom.

4. The rock drilling rig as claimed in claim 1, wherein at least one operational target is a work phase relating to the drilling.

5. The rock drilling rig as claimed in claim 1, wherein the first camera is a pan-tilt-zoom camera, allowing directing and zooming of the operational targets.

6. The rock drilling rig as claimed in claim 5, wherein target views of the first camera are predetermined for the operational targets; and
the target views are stored in a memory media readable by the control unit.

7. The rock drilling rig as claimed in claim 6, wherein the target views are taught to the control unit by manual control of directing and zooming of the first camera.

8. The rock drilling rig as claimed in claim 5, wherein the operational target is moved during the monitoring and the rock drilling rig further comprises a measuring device arranged to determine an actual position of the monitored operational target, wherein the control unit is configured to control directing of the first camera to automatically follow the moving operational target.

9. The rock drilling rig as claimed in claim 8, wherein the first camera is arranged to follow the moving target in steps, whereby the directing procedure of the first camera includes alternating still periods and moving periods having predetermined durations.

10. The rock drilling rig as claimed in claim 8, wherein the speed of the directing and zooming of the first camera during the automatic following procedure is adjustable.

11. The rock drilling rig as claimed in claim 1, further comprising several first cameras having fixed directions, whereby each of the first cameras has one single operational target.

12. The rock drilling rig as claimed in claim 1, wherein the control unit is configured to display on the display device target views of the operational targets according to control commands received from the first control device of the drilling boom or the second control device of the drilling unit, whereby actively controlled operational targets are displayed.

13. The rock drilling rig as claimed in claim 1, wherein a user interface of the control unit includes at least one fast select allowing the operator to select the desired operational target and prioritize displaying of the selected operational target on the display device.

14. The rock drilling rig as claimed in claim 1, wherein the control unit is provided with at least one drilling sequence allowing an automatic control of drilling work phases of at least one drill hole; different operational targets and target views are determined for at least some predetermined drilling work phases of the drilling sequence; and execution of the drilling sequence in the control unit is configured to automatically change the target views on the display device according to the progress of the drilling process.

15. The rock drilling rig as claimed in claim 1, wherein the user interface includes at least a control member allowing manual directing and zooming of the first camera to desired targets.

16. The rock drilling rig as claimed in claim 1, wherein the rock drilling rig is an unmanned device remote controlled by teleoperation, and the control unit, the user interface, the display device and the first and second control devices are located remote from the rock drilling rig, wherein the operation of the rock drilling rig is controlled by a remote operator on the basis of the video monitoring data displayed on the display device.

17. The rock drilling rig as claimed in claim 1, wherein the rock drilling rig is a manned device controlled by an on-board operator, the control unit being configured to display on the display unit visual data of the operational targets for assisting the on-board operator.

18. The rock drilling rig as claimed in claim 1, further comprising a control cabin the first camera being located inside the control cabin.

19. The rock drilling rig as claimed in claim 18, wherein the first camera is located on the carrier or on top of a control cabin.

20. The rock drilling rig as claimed in claim 1, wherein the first camera includes a night vision system allowing video monitoring in darkness.

21. The rock drilling rig as claimed in claim 1, further comprising at least one second camera allowing video monitoring of at least one drive direction of the carrier.

22. A method of monitoring rock drilling, the method comprising:
drilling at least one drill hole into a rock surface with a rock drilling rig including at least one drilling boom and a drilling unit arranged at a distal end of the drilling boom;
monitoring the drilling with at least one video monitoring camera; and by
displaying on a display device several different monitoring camera views of predefined operational phases and objects relating to the drilling.

23. The method as claimed in claim 22, further comprising monitoring drilling phases by at least one control unit; and
displaying automatically a monitoring camera view of a current drilling phase.

24. The method as claimed in claim 22, further comprising monitoring manual control commands received by at least one control unit; and displaying automatically a monitoring camera view relating to a currently controlled object of the rock drilling rig.

25. A computer program product,
having a program code configured to execute the method of 22 when being run on a computer.
